(19) United States
(12) Patent Application Publication
(10) Pub. No.: US 2017/0011386 A1
(43) Pub. Date: Jan. 12, 2017

(54) CARDS, COMPONENT MODULES, MANUAL INPUT DEVICES, DYNAMIC SECURITY CODES AND METHODS OF FORMING ELECRONIC CARDS

(71) Applicant: Dynamics Inc., Cheswick, PA (US)

(72) Inventors: Jeffrey D. Mullen, Glenshaw, PA (US); Norman E. O'Shea, Seven Fields, PA (US); Allen D. Bowers, Aspenwall, PA (US); Andrew Veter, Pittsburgh, PA (US)

(21) Appl. No.: 15/153,458

(22) Filed: May 12, 2016

Related U.S. Application Data
(60) Provisional application No. 62/195,773, filed on Jul. 22, 2015.
(60) Provisional application No. 62/189,740, filed on Jul. 7, 2015.

(51) Int. Cl. G06Q 20/34; G06F 3/044; G06Q 20/40; G06F 3/02

(52) U.S. Cl. CPC G06Q 20/341; G06F 3/02; G06F 3/044; G06Q 20/4012

(57) ABSTRACT

A device comprising a token creation module operable to create a token; and a payment communication device operable to communicate the token to an external device.

### CROSS-REFERENCE TO RELATED APPLICATION

This application claims the benefit of U.S. Provisional Patent Application No. 62/195,773, titled “CARDS, COMPONENT MODULES, MANUAL INPUT DEVICES, DYNAMIC SECURITY CODES AND METHODS OF FORMING ELECRONIC CARDS,” filed Jul. 22, 2015 (Attorney Docket No. D/154PROV) and U.S. Provisional Patent Application No. 62/189,740, titled “CARDS, COMPONENT MODULES, MANUAL INPUT DEVICES, DYNAMIC SECURITY CODES AND METHODS OF FORMING ELECRONIC CARDS,” filed Jul. 7, 2015 (Attorney Docket No. D/153PROV), which are hereby incorporated by reference herein in their entirety.

### BACKGROUND OF THE INVENTION

Example embodiments relate to devices and transaction systems. For example, electronic cards including component modules and financial transaction systems using dynamic security codes.

### SUMMARY OF THE INVENTION

Two or more polymer layers may be fused together on a lamination machine. Card blanks may be punched from the fused layers. A portion of one surface of the card blank may be removed using a milling machine to form a recessed region including a deep recessed region and a shallow recessed region. The deep recessed region may correspond to the thickness of a component module including one or more components and a reel-to-reel substrate. The shallow recessed region may correspond to a thickness of the reel-to-reel substrate. A component module may be embedded using a reel to reel device by cutting the component module from the reel-to-reel tape and placing the component module into the recessed region. The component module may be adhered using an adhesive or a bonding process, such that the surface of the component (e.g., a processor) is about even with the surface of the card blank material. The module may be adhered prior to cutting or may be severed from the reel-to-reel tape during the adhesion process. For example, a tape section, including a display, a battery, a memory, a manual input device and a second processor, may be cut from a roll and laid over the recess, the size of the tape section corresponding to the size of the recess, such that components (e.g., a display, battery and processor) including the tape are positioned in the deep recess region, and the tape is positioned in the shallow recess region. Heat and/or pressure is applied to the surface of the card including the tape to fuse the tape to the card to form a card assembly. The card assembly is personalized by printing, embossing and/or data transfer to each processor to form a customer card. The card body may be personalized prior to the addition of the component module.

According to some example embodiments, a Personal Identification Number (PIN), or other unlocking functionality, may be provided in an embeddable module for a card via, for example, capacitive buttons. For example, a card may include a processor, display, bridge contacts and capacitive buttons. A user may turn ON the display module by, for example, pressing a button such as a mechanical button or an electrical bridge button. The user may then use a capacitive array on the top of the card to enter a PIN or unlocking code. A visual (e.g., an LED or other light source) or vibrational indicator may be provided to indicate to the user that a capacitive button has been activated. The capacitive buttons, which may be other types of buttons, may be denoted by half circles. The capacitive sensors may be configured to sense a finger adjacent to the buttons. Therefore, the card may be printed with indicia representative of the other half of each button (i.e., an adjacent semi-circle). In doing so, a user may be presented with a printed area (half printed on the display module half printed on the card) that shows a full spherical button.

According to some example embodiments, a display module may be provided to a user, and the user may enter a PIN/unlocking code and, for example, re-enter the same PIN/unlocking code to set a card to that unlocking code. One or more one-time or multiple-time use master reset codes may be included in the card so that if a user forgets his/her PIN/unlocking code, or otherwise wants to reset the code, the card may be returned to an initial PIN/unlocking code setup state.

### BRIEF DESCRIPTION OF THE DRAWINGS

Principles and advantages of the present invention can be more clearly understood from the following detailed description considered in conjunction with the following drawings, in which the same reference numerals denote the same structural elements throughout, and in which:

FIG. 1 shows component modules constructed in accordance with the principles of the present invention;

FIG. 2 shows devices constructed in accordance with the principles of the present invention;

FIG. 3 shows assembly units in accordance with the principles of the present invention;

FIG. 4 shows component modules constructed in accordance with the principles of the present invention;

FIG. 5 shows assembly units in accordance with the principles of the present invention; and

FIG. 6 shows devices constructed in accordance with the principles of the present invention.

### DETAILED DESCRIPTION OF THE INVENTION

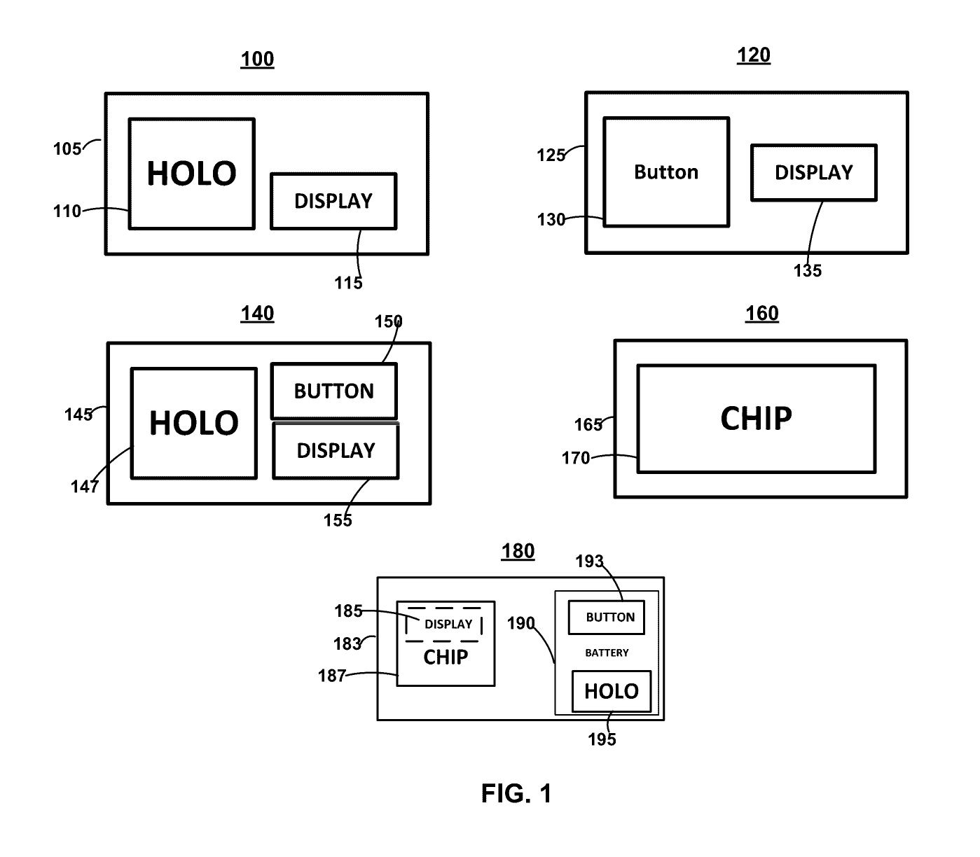

FIG. 1 shows component modules constructed in accordance with the principles of the present invention. FIG. 1 shows example component modules 100, 120, 140, 160 and 180.

Referring to FIG. 1, component module 100 may include, for example, substrate 105, display 110 and display 115. Substrate 105 may include, for example, organic, materials, inorganic materials and combinations thereof. For example, substrate 105 may be a polymer substrate (e.g., PVC, PVCA, PET, PETE and/or the like), a metal substrate (e.g., titanium), a carbon substrate, a composite substrate (e.g., FR-4) and/or a ceramic substrate. Substrate 105 may be flexible, partially flexible, or rigid. Substrate 105 may be transparent, partially transparent or opaque. Substrate 105 may be a printed circuit board (PCB) connecting components of component module 100 to one or more external devices. According to some example embodiments, substrate 105 may be biodegradable. According to some example embodiments, substrate 105 may be a feed substrate, for example, a substrate compatible with reel-to-reel device.

Displays 110 and 115 may static or dynamic displays. For example, each of display 110 and display 115 may be an electrophoretic display (e.g., e-ink), an LCD display, an LED display, a hybrid display, a photograph, a hologram and/or the like. Display 110 and/or display 115 may be a haptic display, a contact responsive display (e.g., touch responsive) and/or a light responsive display. Display 110 may be the same type of display as display 115, or a different type of display.

Substrate 105, display 110 and display 115 may be arranged in component module 100 in correspondence to features of a partially formed device (not shown). For example, the partially formed device may include one or more spaces for display 110, display 115 and/or substrate 105. Substrate 105, display 110 and display 115 may be arranged to fit into the spaces of the partially formed device such that substrate 105, display 110 and/or display 115 complete the partially formed device or complete a portion of the partially formed device.

Substrate 105, display 110 and/or display 115 may, for example, complete or partially complete one or more surfaces of the partially formed device, before or after further processing operations. For example, material may be placed over a portion or all of component module 100 to complete the partially formed device, for example, one or more layers of protective material or graphics material.

According to some example embodiments, substrate 105 may be transparent and complete a surface of the partially formed device, or a portion of the surface of the partially formed device, such that display 115 and/or display 110 is visible through substrate 105. According to some example embodiments, display 110 and display 115 may be embedded in substrate 105 such that a surface of substrate 105, a surface of display 110 and a surface of display 115 complete or partially complete a surface of the partially formed device. According to some example embodiments, the one or more spaces of the partially formed device may be a single recessed region of varying depth. At least a part of the recessed portion may include one or more through-device vias, and, for example, display 115 and/or display 110 may pass through the partially formed device. A surface of substrate 105 may complete or partially complete a surface of the partially formed device through which component module 120 is inserted, and a surface of display 115 and/or a surface of display 110 may complete or partially complete a surface of the device other than the insertion surface.

According to some example embodiments, a visual display of one of displays 110 and 115 may be visible from one side of the device and a visual display of the other of displays 110 and 115 may be visible from the opposite side.

According to at least one example embodiment, substrate 105 may be a detachable substrate used to insert display 110 and display 115 into the one or more spaces.

Component module 120 may include, for example, substrate 125, manual input device 130 and display 135. Substrate 125 may include, for example, organic, materials, inorganic materials and combinations thereof. For example, substrate 125 may be a polymer substrate (e.g., PVC, PVCA, PET, PETE and/or the like), a metal substrate (e.g., titanium), a carbon substrate, a composite substrate (e.g., FR-4) and/or a ceramic substrate. Substrate 125 may be flexible, partially flexible, or rigid. Substrate 125 may be transparent, partially transparent or opaque. According to some example embodiments, substrate 125 may be biodegradable. Substrate 105 may be a printed circuit board (PCB) connecting components of component module 100 and/or connecting component module 110 to one or more external devices. According to some example embodiments, substrate 125 may be a feed substrate, for example, a substrate compatible with reel-to-reel device.

Manual input device 130 may be, for example, a mechanical button, a sensor (e.g., a touch sensor), an accelerometer, a piezoelectric switch, gyroscopic, a pair of contacts or combinations thereof. For example, manual input device 130 may be a pair of contacts connected to a circuit. The circuit may be completed by an object (e.g., a finger and/or a stylus) bridging the contacts, for example, to electrically connect the contacts.

Display 135 may be a static or dynamic display. For example, display 130 may be an electrophoretic display (e.g., e-ink), an LCD display, an LED display, a hybrid display, a photograph, a hologram and/or the like. Display 130 may be a haptic display, a contact responsive display (e.g., touch responsive) and/or a light responsive display.

Substrate 125, manual input device 130 and display 135 may be arranged in component module 120 in correspondence to features of a partially formed device (not shown). For example, the partially formed device may include one or more spaces for manual input device 130, display 135 and/or substrate 125. Substrate 125, manual input device 130 and display 135 may be arranged to fit into the spaces of the partially formed device such that substrate 125, display 135 and/or manual input device 130 complete the partially formed device or complete a portion of the partially formed device.

Substrate 125, manual input device 130 and/or display 135 may, for example, complete or partially complete one or more surfaces of the partially formed device, before or after further assembly operations. According to some example embodiments, material may be placed over a portion or all of component module 120 to complete the partially formed device, for example, one or more layers of protective material or graphics material.

According to some example embodiments, substrate 125 may be transparent, and complete or partially complete a surface of the device such that display 135 and/or manual input device 130 is visible through substrate 125. According to some example embodiments, manual input device 130 and display 135 may be embedded in substrate 125 such that a surface of substrate 125, a surface of manual input device 130 and a surface of display 135 complete or partially complete a surface of the partially formed device. According to some example embodiments, the one or more spaces of the partially formed device may be a single recessed region of varying depth. At least a part of the recessed region may include one or more through-device vias, and, for example, display 135 and/or manual input device 130 may pass through the partially formed device. A surface of substrate 125 may complete or partially complete a surface of the partially formed device through which component module 120 is inserted, and a surface of display 135 and/or a surface of manual input device 130 may complete or partially complete a surface of the device other than the insertion surface.

According to some example embodiments, a visual display of display 135 may be visible from one side of the device and a surface of manual input device 130 may be visible from the opposite side. According to at least one example embodiment, substrate 125 may be a detachable substrate used to insert manual input device 130 and display 135 into the one or more spaces.

Component module 140 may include, for example, substrate 145, manual input device 150, and displays 147 and 155. Substrate 145 may include, for example, organic, materials, inorganic materials and combinations thereof. For example, substrate 145 may be a polymer substrate (e.g., PVC, PVCA, PET, PETE and/or the like), a metal substrate (e.g., titanium), a carbon substrate, a composite substrate (e.g., FR-4) and/or a ceramic substrate. Substrate 145 may be flexible, partially flexible, or rigid. Substrate 145 may be transparent, partially transparent or opaque. Substrate 105 may be a printed circuit board (PCB) connecting components of component module 100 and/or connecting component module 110 to one or more external devices. According to some example embodiments, substrate 145 may be biodegradable. According to some example embodiments, substrate 145 may be a feed substrate, for example, a substrate compatible with reel-to-reel device.

Manual input device 150 may be, for example, a mechanical button, a sensor (e.g., a touch sensor), an accelerometer, a piezoelectric switch, gyroscopic, a pair of contacts or combinations thereof. For example, manual input device 150 may be a pair of contacts connected to a circuit. The circuit may be completed by an object (e.g., a finger and/or a stylus) bridging the contacts, for example, to electrically connect the contacts.

Displays 147 and 155 may static or dynamic displays. For example, each of displays 147 and 155 may be an electrophoretic display (e.g., e-ink), an LCD display, an LED display, a hybrid display, a photograph, a hologram and/or the like. Display 147 and/or display 155 may be a haptic display, a contact responsive display (e.g., touch responsive) and/or a light responsive display. Display 147 may be the same type of display as display 155, or a different type of display.

Substrate 145, manual input device 150, display 147 and display 155 may be arranged in component module 120 in correspondence to features of a partially formed device (not shown). For example, the partially formed device may include one or more spaces for manual input device 150, display 147, display 155 and/or substrate 145. Substrate 145, manual input device 150, display 147 and display 155 may be arranged in component module 140 to fit into the spaces of the partially formed device such that substrate 145, display 147, display 155 and/or manual input device 150 complete the partially formed device or complete a portion of the partially formed device.

Substrate 145, manual input device 150, display 147 and/or display 155 may, for example, complete or partially complete one or more surfaces of the partially formed device, before or after further assembly operations. According to some example embodiments, material may be placed over a portion or all of component module 140 to complete the partially formed device, for example, one or more layers of protective material or graphics material.

According to some example embodiments, substrate 145 may be transparent and complete or partially complete a surface of the device such that one or more of display 147, display 155 and/or manual input device 150 is visible through substrate 145. According to some example embodiments, one or more of manual input device 150, display 147 and display 155 may be embedded in substrate 145 (e.g., an opaque substrate) such that one or more of a surface of substrate 145, a surface of manual input device 150, a surface of display 147 and a surface of display 155 complete or partially complete a surface of the partially formed device. According to some example embodiments, the one or more spaces of the partially formed device may be a single recessed region of varying depth. At least a part of the recessed region may include one or more through-device via, and, for example, display 147, display 155 and/or manual input device 150 may pass through the partially formed device. A surface of substrate 145 may complete or partially complete a surface of the partially formed device through which component module 140 is inserted, and one or more of a surface of display 147, a surface of display 155 and a surface of manual input device 150 may complete or partially complete a surface of the device opposite from the insertion surface.

According to some example embodiments, a visual display of display 147, a visual display of display 155, and a surface of manual input device 150 may be visible from different sides of the device according to the arrangement of component module 140 (e.g., a transparent substrate, or an embedded substrate and a recessed region with through-device vias). As one example, a visual display of display 147 and a surface of manual input device 150 may be visible from one side of the device, and a visual display of display 155 may be visible from the opposite side of the device.

According to at least one example embodiment, substrate 145 may be a detachable substrate used to insert manual input device 150 and displays 147 and 155 into the one or more spaces.

Component module 160 may include, for example, substrate 165 and integrated circuit (IC) chip 170. Substrate 165 may include, for example, organic, materials, inorganic materials and combinations thereof. For example, substrate 165 may be a polymer substrate (e.g., PVC, PVCA, PET, PETE and/or the like), a metal substrate (e.g., titanium), a carbon substrate, a composite substrate (e.g., FR-4) and/or a ceramic substrate. Substrate 165 may be flexible, partially flexible, or rigid. Substrate 165 may be transparent, partially transparent or opaque. Substrate 165 may be a printed circuit board (PCB) connecting components of component module 100 and/or connecting component module 110 to one or more external devices. According to some example embodiments, substrate 165 may be biodegradable. According to some example embodiments, substrate 165 may be a feed substrate, for example, a substrate compatible with reel-to-reel device.

IC chip 170 may be, for example, a processor, an application specific integrated circuit (ASIC) and/or a memory. According to some example embodiments, IC chip 170 may be an EMV chip (e.g., an EMV compliant processor).

Substrate 165 and IC chip 170 may be arranged in component module 160 in correspondence to features of a partially formed device (not shown). For example, the partially formed device may include one or more spaces for substrate 165 and/or IC chip 170. Substrate 165 and IC chip 170 may be arranged to fit into the spaces of the partially formed device such that substrate 165 and/or IC chip 170 complete the partially formed device or complete a portion of the partially formed device.

Substrate 165 and IC chip 170 may, for example, complete or partially complete one or more surfaces of the partially formed device, before or after further assembly operations. According to some example embodiments, material may be placed over all or a portion of substrate 165, and over a portion IC chip 170, to complete the partially formed device, for example, one or more layers of protective material or graphics material.

According to some example embodiments, IC chip 170 may be embedded in substrate 165 such that IC chip 170 penetrates through substrate 165 or is exposed as a portion of a recess of substrate 165. One or more surfaces of IC chip 170 may be contiguous with a surface of substrate 165. According to some example embodiments, the one or more spaces of the partially formed device may be a single recessed region of varying depth. At least a part of the recessed region may include a through-device via, and, for example, IC chip 170 may be adhered to substrate 165 and pass through the partially formed device. A surface of substrate 165 may complete or partially complete a surface of the partially formed device through which component module 160 is inserted, and a surface of IC chip 170 may complete or partially complete a surface of the device other than the insertion surface.

According to at least one example embodiment, substrate 165 may be a detachable substrate used to insert IC chip 170 into the one or more spaces.

Component module 180 may include, for example, substrate 183, display 185, IC chip 187, manual input device 193, power supply 190 and display 195.

Substrate 183, display 185, IC chip 187, manual input device 193, and display 195 may be arranged as a variation of the arrangements disclosed above.

Power supply 190 may include, for example, a battery, RF harvesting device, and/or a power regulating device. As shown using a dashed box, display 185 may be stacked underneath IC chip 187. Similarly, power supply 190 may be stacked with manual input device 193 and display 195. IC chip 187 may be, for example, embedded in substrate 183, on an opposite side of substrate 183 from display 185, or stacked with display 185 on one side of substrate 183. Display 185 may be, for example, embedded in substrate 183, on an opposite side of substrate 183 from IC chip 187, or stacked with IC chip 187 on one side of substrate 183. Manual input device 193 and display 195 may be, for example, embedded in substrate 183, on an opposite side of substrate 183 from power supply 190 or stacked with power supply 190 on one side of substrate 183.

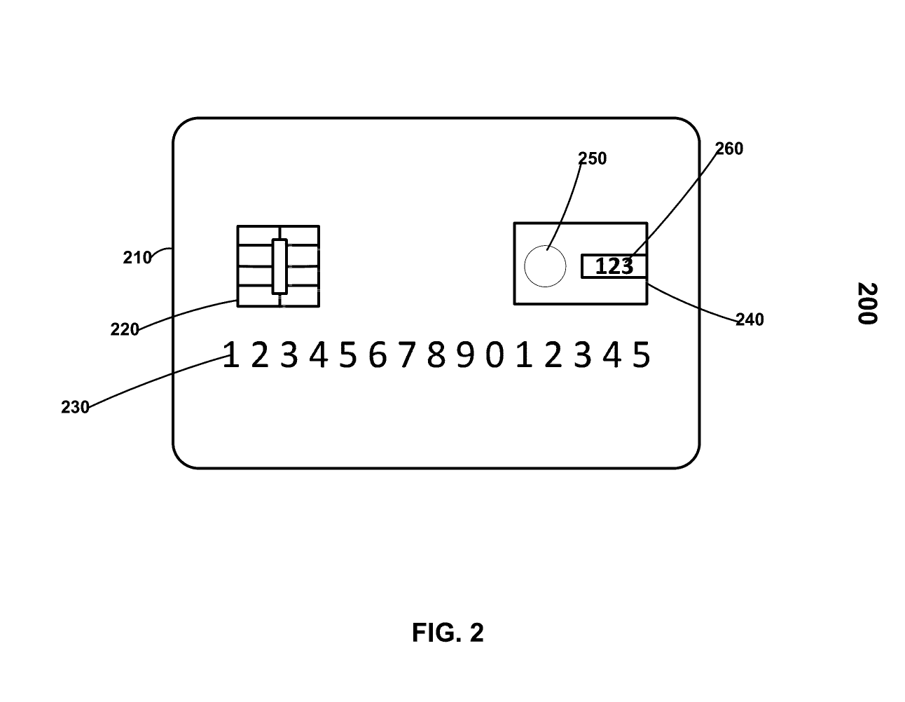

FIG. 2 shows devices constructed in accordance with the principles of the present invention. Referring to FIG. 2, device 200 may be, for example, an electronic card including substrate 210, processor 220, display 230 and component module 240. Substrate 210 may include, for example, one or more polymer layers. According to at least one example embodiment, substrate 210 may include conductive traces. Processor 220 may be, for example, an EMV chip. Display 230 may be, for example, information printed on substrate 210. Component module 240 may include button 250 and display 260. Button 250 may be, for example, a mechanical dome button. Display 260 may be, for example, an electrophoretic, bi-stable display.

A portion of component module 240 not including button 250 and display 260 may be a component module substrate. The component module substrate may, for example, fill portions of a recess in substrate 210 not occupied by button 250 and display 260.

According to some example embodiments, the component module substrate may be one or more polymer layers. According to other example embodiments, the component module substrate may include conductive traces. The conductive traces of the component module substrate may connect button 250 and display 260. According to at least one example embodiment, the conductive traces of the component module substrate connect button 250 and display 260, and connec to conductive traces of substrate 210 and/or to devices outside of component module 240 (e.g., a battery and/or processor 220). For example, the component module substrate and substrate 210 may be interconnected, flexible printed circuit boards.

The component module substrate may be fixed within a recess of substrate 210, for example, by an adhesive and/or as a result of a bonding process (e.g., using localized heat and pressure to fuse the component module substrate to substrate 210).

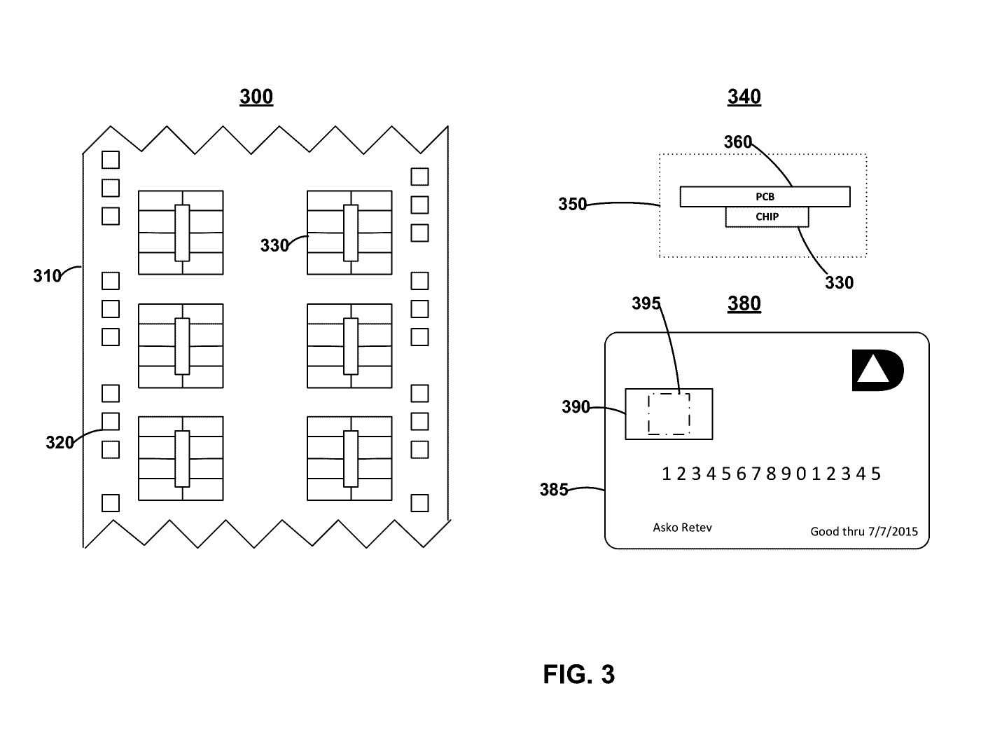

FIG. 3 shows assembly units 300, 340 and 380 in accordance with the principles of the present invention. Assembly unit 300 shows a portion of reel-to-reel tape 310 including sprocket holes 320 and an integrated circuit (IC) chip 330 (e.g., an EMV chip).

Assembly unit 340 shows a cross-section of a component module 350. Component module 350 may include, for example, a portion of reel-to-reel tape 330 including a printed circuit board (PCB) 360 and IC chip 330. PCB 360 may extend outside the footprint of IC chip 330. According to some example embodiments, IC chip 330 is fixed to a surface of PCB 360. According to at least one example embodiment IC chip 330 may extend through PCB 360 such that a surface of PCB 360 and a surface of IC chip 330 are contiguous or roughly contiguous.

Assembly unit 385 shows a personalized financial card body 385. Card body 385 includes a recessed region 390. Recessed region 390 includes deep recessed region 395. A depth into card body 385 of deep recessed region 395 is greater than a depth of portions of recessed region 390 outside of deep recessed region 395. The depth of deep recessed region 395 may correspond to, for example, a thickness of PCB 360 and IC chip 330, and/or deep recessed region 395 may be a through-device via extending through card body 385. A depth of portions of recessed region 390 outside of deep recessed region 395 may correspond to, for example, a thickness of PCB 360.

According to some example embodiments, a thickness of PCB 360 is greater than a depth of portions of recessed region 390 outside of deep recessed region 395 by an amount of thickness lost during a bonding process used to bond component module 350 to card body 385. According to some example embodiments, a thickness of PCB 360 is less than a depth of portions of recessed region 390 outside of deep recessed region 395 by an amount of thickness contributed by an adhesive used to bond component module 350 to card body 385. According to at least one example embodiment, a thickness of PCB 360 is about the same as a depth of portions of recessed region 390 outside of deep recessed region 395.

Component module 350 may be positioned in recessed region 390 such that a surface of IC chip 370 is contiguous with the depicted surface of card body 385 after assembly and/or a surface of IC chip 370 may be contiguous with the opposite side of card body 385 (not shown). According to at least one example embodiment, IC chip 370 includes contact pads on both major surfaces and contact pads are exposed on both sides of card body 385.

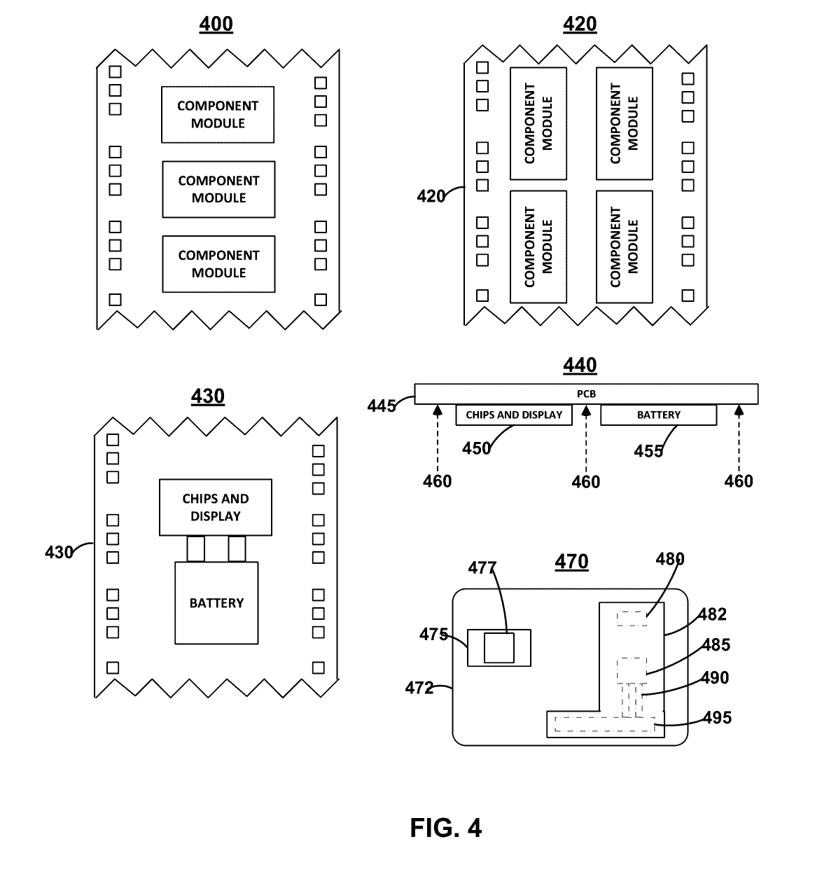

FIG. 4 shows assembly units 400, 420, 430 440 and 470 in accordance with the principles of the present invention.

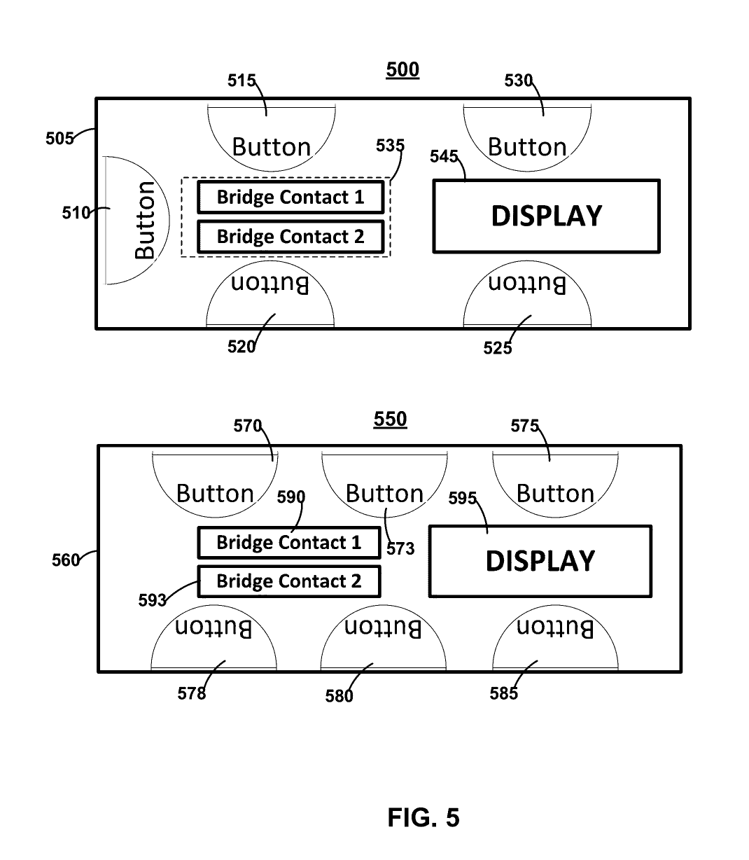

FIG. 5 shows component modules constructed in accordance with the principles of the present invention. FIG. 5 shows example component modules 500 and 550.

Referring to FIG. 5, component module 500 may include, for example, substrate 505, manual input device 510, manual input device 515, manual input device 520, manual input device 525, manual input device 530, manual input device 535 and/or display 545.

Substrate 505 may include, for example, organic, materials, inorganic materials and combinations thereof. For example, substrate 505 may be a polymer substrate (e.g., PVC, PVCA, PET, PETE and/or the like), a metal substrate (e.g., titanium), a carbon substrate, a composite substrate (e.g., FR-4) and/or a ceramic substrate. Substrate 505 may be flexible, partially flexible, or rigid. Substrate 505 may be transparent, partially transparent or opaque. Substrate 505 may be a printed circuit board (PCB) connecting components of component module 500 to one or more external devices. According to some example embodiments, substrate 505 may be biodegradable. According to some example embodiments, substrate 505 may be a feed substrate, for example, a substrate compatible with reel-to-reel device.

Manual input devices 510, 515, 520, 525 and 530 may be, for example, mechanical buttons, sensors (e.g., capacitive sensors, resistive sensors, infrared sensors, surface acoustic wave (SAW) sensors, and/or inductive sensors), an accelerometer, a piezoelectric switch, gyroscopic, a pair of contacts or combinations thereof.

Manual input device 535 (shown in plan view within the dashed rectangle) may include, for example, one or more contacts (e.g., bridge contacts) connected to a circuit. The circuit may be completed by an object (e.g., a finger and/or a stylus) bridging the contacts, for example, electrically connecting the contacts to activate manual input device 535 (e.g., register an input).

According to some example embodiments, a conductivity of a bridging object sufficient to activate manual input device 535 may be greater than a conductivity of a finger, or less than or equal to (≦) the conductivity of a finger. Manual input device 535 may, for example, be activated by a finger and not activated by a highly conductive object (e.g., metal). Manual input device 535 may not, for example, be activated by a finger and may be activated by a highly conductive object.

Manual input device 535 may be connected to a detection circuit (not shown), for example, an integrated circuit such as an ASIC or a processor. The detection circuit may determine the conductivity of an object bridging a plurality of the contacts by, for example, detecting a magnitude of a current in the circuit upon bridging and/or detecting a voltage difference between contacts. Manual input device 535 may be connected to a detection circuit that detects a single type of bridging object (e.g., a finger), or discriminates between two or more bridging objects (e.g., a finger, a pen, a plastic card, a metal key, a cell phone case, coins and/or clothing). According some example embodiments, manual input device may include three or more contacts to detect conductivity with greater precision. According to some example embodiments, contacts of manual input device 535 may be spaced apart a distance, for example, a finger length distance or a card length distance. False activations may be decreased and/or prevented.

Each of manual input devices 510-535 may include the same type of sensor or each may include a different type of sensor from every other one of manual input devices 510-535. According to example embodiments, any combination of types of sensors is contemplated. For example, two or more manual input devices may be capacitive touch sensors, and one or more manual input devices may be inductive touch sensors. According to some example embodiments, one or more of manual input devices 510-535 may be activated by a user's finger, and different devices of manual input devices 510-535 may be activated by a conductive object (e.g., a metal tipped stylus) and not activated by a user's finger.

Display 545 may be a static or dynamic display. For example, display 545 may be an electrophoretic display (e.g., e-ink), an LCD display, an LED display, a hybrid display, a photograph, a hologram and/or the like. Display 545 may be a haptic display, a contact responsive display (e.g., touch responsive) and/or a light responsive display.

Substrate 505, manual input devices 510-535, and display 545 may be arranged in component module 500 in correspondence to features of a partially formed device (not shown). For example, the partially formed device may include one or more spaces for substrate 505, manual input devices 510-535 and display 545. Substrate 505, manual input devices 510-535, and display 545 may be arranged to fit into the spaces of the partially formed device such that substrate 505, manual input devices 510-535 and display 545 complete the partially formed device or complete a portion of the partially formed device.

Substrate 505, manual input devices 510-535 and/or display 545 may, for example, complete or partially complete one or more surfaces of the partially formed device, before or after further processing operations. For example, material may be placed over a portion or all of component module 500 to complete the partially formed device, such as one or more layers of protective material or graphics material. A protective layer on manual input devices 510-535 may be contiguous, may include openings exposing manual input devices 510-535, may be conductive, may be partially conductive and/or may be variably conductive.

According to some example embodiments, substrate 505 may be transparent and complete a surface of the partially formed device, or a portion of the surface of the partially formed device, such that display 545 and/or one or more of manual input devices 510-535 are visible through substrate 505. According to some example embodiments, display 545 and/or one or more of manual input devices 510-535 may be embedded in substrate 505, such that a surface of substrate 505, a surface of display 545 and/or a surface of one or more of manual input devices 510-535 complete or partially complete a surface of the partially formed device.

According to some example embodiments, the one or more spaces of the partially formed device may be a single recessed region of varying depth corresponding to thicknesses of substrate 505, manual input devices 510-535 and/or display 545. According to some example embodiments, at least a part of the recessed portion may include one or more through-device vias, and for example, display 545 and/or one or more of manual input devices 510-535 may pass through the partially formed device. A surface of substrate 505 may complete or partially complete a surface of the partially formed device through which component module 500 is inserted, and a surface of display 545 and/or one or more of manual input devices 510-535 may complete or partially complete a surface of the device other than the insertion surface.

According to at least one example embodiment, substrate 505 may be a detachable substrate used to insert display 545 and manual input devices 510-535 into the one or more spaces. According to some example embodiments, circuits external to component module 500 may be directly connected to display 545 and manual input devices 510-535 and/or may be connected via substrate 505. Substrate 105 may be, for example, a circuit board connecting components of component module 500 to each other and/or to external circuits (e.g., external devices and/or one or more circuit boards external to component module 500).

Component module 550 may include, for example, substrate 560, manual input device 570, manual input device 573, manual input device 575, manual input device 578, manual input device 580, manual input device 585, contacts 590 and 593, and/or display 595.

Substrate 560 may include, for example, organic, materials, inorganic materials and combinations thereof. For example, substrate 560 may be a polymer substrate (e.g., PVC, PVCA, PET, PETE and/or the like), a metal substrate (e.g., titanium), a carbon substrate, a composite substrate (e.g., FR-4) and/or a ceramic substrate. Substrate 560 may be flexible, partially flexible, or rigid. Substrate 560 may be transparent, partially transparent or opaque. Substrate 560 may be a printed circuit board (PCB) connecting components of component module 550 to one or more external devices. According to some example embodiments, substrate 560 may be biodegradable.

According to some example embodiments, substrate 560 may be a feed substrate, for example, a substrate compatible with reel-to-reel device.

Manual input devices 570-585 may be, for example, mechanical buttons, sensors (e.g., capacitive sensors, resistive sensors, infrared sensors, surface acoustic wave (SAW) sensors, and/or inductive sensors), an accelerometer, a piezoelectric switch, gyroscopic, a pair of contacts or combinations thereof.

Contacts 590 and 593 may be, for example, one or more contacts connected to a circuit. The circuit may be completed by an object (e.g., a finger and/or a stylus) bridging the contacts, for example, electrically connecting the contacts to activate manual input device 535 (e.g., to register an input).

According to some example embodiments, manual input device 535 may be activated by an object in proximity to or touching one or more of contacts 590 and 593 in a capacitive sensing mode. For example, contacts 590 and 593 may together or individually act as a plate of a capacitive element including an object external to component module 550. As another example, contacts 590 and 593 may individually act as different plates of different capacitive elements including an object external to component module 550.

The external object may form a second plate and/or dielectric of the capacitive element. For example, a detection circuit (not shown) including contact 590 may detect a capacitance change when an external object is in proximity and separated from contact 590 (e.g., separated by air). As another example, contact 593 may be covered by an insulating protective layer and a detection circuit (not shown) including contact 593 may detect a capacitive change when an external object is in proximity to or contacts the insulating protective layer. As yet another example, contacts 590 and 593 may be covered by an insulating protective layer and a detection circuit (not shown) including contacts 590 and 593 may detect a capacitive change at each of contacts 590 and 593 when an external object contacts the insulating protective layer.

According to some example embodiments, an activation may occur when a capacitance change is detected with respect to either or both of contacts 590 and 593. According to some example embodiments, an activation may only occur when a capacitance change is detected with respect to only one of contacts 590 and 593. According to some example embodiments, an activation may only occur when a capacitance change is detected with respect to both of contacts 590 and 593.

Persons of ordinary skill will appreciate that a fewer or greater number of contacts may be included. For example, an array of contacts may be included and an activation may only occur when a detection circuit detects a capacitance change associated with a specific set of contacts within the array (e.g., at the same time, in sequence and/or repetitively). According to at least one example embodiment, an activation may occur upon detection of a change in capacitance associated with a single contact of an array.

According to some example embodiments, a conductivity of a bridging object sufficient to activate a circuit (not shown) connected to contacts 590 and 593 may be greater than a conductivity of a finger, or less than or equal to (≦) the conductivity of a finger. The circuit may, for example, be activated by a finger and not activated by a highly conductive object (e.g., metal). The circuit, for example, may not be activated by a finger and may be activated by a highly conductive object.

Contacts 590 and 593 may be connected to a detection circuit (not shown), for example, an integrated circuit such as an ASIC or a processor. The detection circuit may determine the conductivity of an object bridging two or more of the contacts by, for example, detecting a magnitude of a current in the circuit upon bridging and/or detecting a voltage difference between contacts. Contacts 590 and 593 may be connected to a detection circuit that detects a single type of bridging object (e.g., a finger), or discriminates between two or more bridging objects (e.g., a finger, a pen, a plastic card, a metal key, a cell phone case, coins and/or clothing). According some example embodiments, component module 550 may include three or more contacts. According to some example embodiments, contacts 590 and 593 (and any other contacts) may be spaced apart a distance, for example, a finger length distance, a card length distance and/or increments thereof. False activations may be decreased and/or prevented.

Each of manual input devices 570-585 may include the same type of device or a different type of device from every other one of manual input devices 570-585. According to example embodiments, any combination of types of devices is included. For example, two or more manual input devices may be capacitive touch sensors, and two or more manual input devices may be mechanical buttons.

According to some example embodiments, one or more of manual input devices 570-585 may be activated by a user's finger, and different manual input devices of manual input devices 570-585 may be activated by a conductive object (e.g., a metal tipped stylus) and not activated by a user's finger.

Display 595 may be a static or dynamic display. For example, display 595 may be an electrophoretic display (e.g., e-ink), an LCD display, an LED display, a hybrid display, a photograph, a hologram and/or the like. Display 595 may be a haptic display, a contact responsive display (e.g., touch responsive) and/or a light responsive display.

Substrate 560, manual input devices 570-585, contacts 590 and 593, and display 595 may be arranged in component module 550 in correspondence to features of a partially formed device (not shown). For example, the partially formed device may include one or more spaces for substrate 560, manual input devices 570-585, contacts 590 and 593, and display 595. Substrate 560, manual input devices 570-585, contacts 590 and 593, and display 595 may be arranged to fit into the spaces of the partially formed device such that they complete the partially formed device or complete a portion of the partially formed device.

Substrate 560, manual input devices 570-585, contacts 590 and 593, and display 595 may, for example, complete or partially complete one or more surfaces of the partially formed device before or after further processing operations. For example, material may be placed over a portion or all of component module 550 to complete the partially formed device, such as one or more layers of protective material and/or graphics material. A protective layer on manual input devices 570-585, and/or contacts 590 and 593, may be contiguous, may include openings exposing one or more of manual input devices 570-585 and contacts 590 and 593, may be conductive, may be partially conductive and/or may be variably conductive.

According to some example embodiments, substrate 560 may be transparent and complete a surface of the partially formed device, or a portion of the surface of the partially formed device, such that display 595 is visible through substrate 560. According to some example embodiments, manual input devices 570-585, contacts 590 and 593, and display 595 may be embedded in substrate 560 such that a surface of substrate 560, surfaces of manual input devices 570-585, surfaces of contacts 590 and 593, and a surface of display 595 complete or partially complete a surface of the partially formed device.

According to some example embodiments, the one or more spaces of the partially formed device may be a single recessed region of varying depth corresponding to thicknesses of substrate 560, manual input devices 570-585, contacts 590 and 593, and/or display 595. According to some example embodiments, at least a part of the recessed portion may include one or more through-device vias, and, for example, display 595 one or more of contacts 590 and 593, and/or one or more of manual input devices 570-585 may pass through the partially formed device. A surface of substrate 560 may complete or partially complete a surface of the partially formed device through which component module 550 is inserted, and a surface of display 595, one or more surfaces of contacts 590 and 593 and/or one or more of manual input devices 570-585 may complete or partially complete a surface of the device other than the insertion surface.

According to at least one example embodiment, substrate 560 may be a detachable substrate used to insert display 595, contacts 590 and 593, and manual input devices 570-585, into the one or more spaces. According to some example embodiments, circuits external to component module 550 may be directly connected to display 595, contacts 590 and 593, and manual input devices 570-585, and/or may be connected via substrate 560. Substrate 560 may be, for example, a circuit board connecting components of component module 550 to each other and/or to external circuits (e.g., external devices and/or a circuit board external to component module 550).

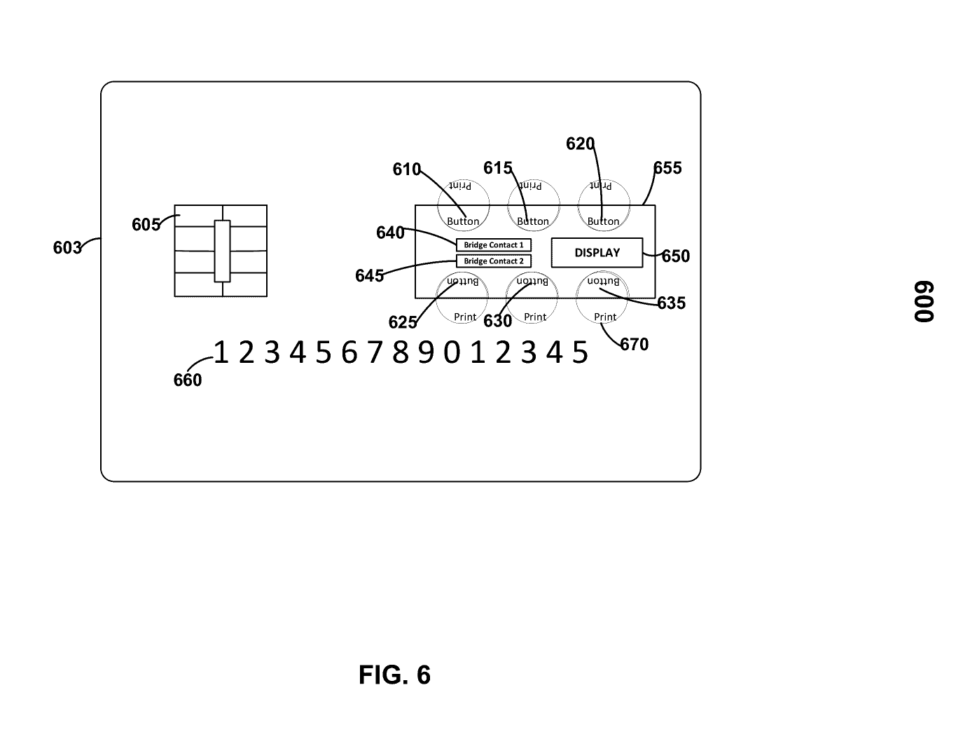

FIG. 6 shows devices constructed in accordance with the principles of the present invention. Referring to FIG. 6, device 600 may be, for example, an electronic card including substrate 603, processor 605, display 660, displays 670 and/or a component module. The component module may include, for example, component module substrate 655, manual input interface 610, manual input interface 615, manual input interface 620, manual input interface 625, manual input interface 630, manual input interface 635, bridge contact 640, bridge contact 645 and/or display 650.

According to some example embodiments, component module substrate 655 may include one or more polymer layers and/or conductive traces. The conductive traces may connect various components of the component module to each other and/or to devices external to the component module (e.g., a battery and/or processor). According to some example embodiment, the conductive traces of the component module substrate may connect manual input interfaces 610-635, bridge contacts 640 and 645, and display 650 to, for example, one or more processors. The one or more processors may be included in the component module (not shown) and/or external to the component module (e.g., processor 605). One of manual input interfaces 610-635 may supply a signal to a processor. The processor may drive the display 650 to display a code in response to the signal. The code may be, for example, a code that changes with time (e.g., a dynamic card verification code (CVV)).

Connections between components of the component module and devices external to the component module may be direct connections (e.g., wire bonding) and/or indirect connections (e.g., one or more circuit board). For example, component module substrate 655 and substrate 603 may be interconnected, flexible printed circuit boards, and components of the component module may be connected to devices external to the component module via the circuit boards.

The component module substrate including manual input interfaces 610-635, bridge contacts 640 and 645 and/or display 650 may be fixed within a recess of substrate 210 (not shown), for example, by an adhesive and/or as a result of a bonding process (e.g., using localized heat and pressure to fuse the component module to substrate 603).

Manual input interfaces 610-635, together with displays 670 (e.g., printing), may display the appearance of a symmetrical interface. For example, manual input interface 635 may appear as a half-circle button. Display 670 may be, for example, a printed image of a half circle (e.g., mirror image of a manual input interface). The combination of manual input interface 635 and display 670 may provide the appearance of a circular button. Manual input interface 635 may provide a button function while display 670 may provide a symmetrical appearance.

Although the combination of manual input interface 635 and display 670 is described with respect to a circle, example embodiments may be any shape. For example, any shape generally composed of straight line segments, any shape including curves, with or without circular arcs, irregular shapes and/or any shape with curves, straight line segments or a combination thereof. According to some example embodiments, a manual input interface and a display may complete an image, symbol and/or the like. According to at least one example embodiment, display 670 and manual input interface 635 both provide a button function.

According to at least one non-limiting example, substrate 603 may include one or more polymer layers with conductive traces, processor 605 may be an exposed IC chip (e.g., an EMV chip), displays 660 and 670 may be information printed or embossed on substrate 603, display 650 may be an electrophoretic, bi-stable display, manual input interfaces 610-635 may be touch sensors with respect to unlocking functionality (e.g., used to input a personal identification number (PIN)), bridge contacts 640 and 645 may be a manual user interface (e.g., an ON/OFF button), and substrate 655 may be a component module substrate in portions of a recess of substrate 603 that do not include manual input interfaces 610-635, bridge contacts 640 and 645 and/or display 650.

According to example embodiments, a component module may include any combination of elements. For example, a component module may include processor 605 (not shown). As another example, a component module may include display 660 (not shown). As yet another example, a component module may include every element of card 600 except for substrate 630 (not shown).

Persons skilled in the art will appreciate that various elements of different example embodiments may be combined in various ways. For example, a component module including multiple components may include any number and/or combination of components and/or types of components. As another example,

Persons skilled in the art will also appreciate that the present invention is not limited to only the embodiments described. Instead, the present invention more generally involves dynamic information. Persons skilled in the art will also appreciate that the apparatus of the present invention may be implemented in other ways than those described herein. All such modifications are within the scope of the present invention, which is limited only by the claims that follow.

What is claimed is:

1. A device comprising:
a battery;
a display operable to display information;
a display controller operable to control the display
a plurality of buttons operable to accept a PIN; and
toggle button operable to communicate with the display controller to change the information displayed once the PIN is accepted.

2. The device of claim 1, further comprising memory operable to store a first information and a second information.

3. The device of claim 1, further comprising a communication device.

4. The device of claim 1, further comprising a dynamic magnetic communication stripe.

5. The device of claim 1, further comprising a wireless communication device.

6. The device of claim 1, further comprising an RFID.

7. The device of claim 1, further comprising an IC chip.

8. The device of claim 1, wherein data communicated by a communication device is associated with the information displayed on the display.

9. The device of claim 1, wherein the toggle button is operable to cause the display controller to replace a first information on the display with a second information upon activation of the toggle button.

10. The device of claim 1, wherein the toggle button is operable to cause the display controller to replace a first information on the display with a second information upon a first type of activation of the toggle button and operable to cause the display controller to replace a first information on the display with a third information upon a second type of activation of the toggle button.

11. The device of claim 1, wherein the toggle button is operable to cause the display controller to replace a first information on the display with a second information upon activation of the toggle button wherein the first and second information are related.

12. The device of claim 1, wherein the toggle button is operable to cause the display controller to replace a first information on the display with a second information upon activation of the toggle button wherein the first and second information are related to different payment cards.

13. A device comprising:
a token creation module operable to create a token; and
a payment communication device operable to communicate the token to an external device.

14. The device of claim 13, wherein the token creation module is operable to retrieve the token from memory.

15. The device of claim 13, wherein the token creation module is operable to generate the token in response to a request.

16. The device of claim 13, further comprising a reader detection module operable to determine a type of reader.

17. The device of claim 13, wherein the token creation module is operable to create a token based on a type of reader detected.
